(19) United States
(12) Patent Application Publication
(10) Pub. No.: US 2022/0163426 A1
(43) Pub. Date: May 26, 2022

(54) METHOD AND APPARATUS FOR DETERMINING SERVICE LIFE OF BEARING

(71) Applicant: CRRC QINGDAO SIFANG CO., LTD., Qingdao, Shandong (CN)

(72) Inventors: Jianwen HOU, Qingdao, Shandong (CN); Xiaohong DONG, Qingdao, Shandong (CN); Yuejun ZHANG, Qingdao, Shandong (CN)

(73) Assignee: CRRC QINGDAO SIFANG CO., LTD., Qingdao, Shandong (CN)

(21) Appl. No.: 17/598,906

(22) PCT Filed: Sep. 4, 2019
(86) PCT No.: PCT/CN2019/104309

§ 371 Date: Sep. 28, 2021

(30) Foreign Application Priority Data
Apr. 1, 2019 (CN) 201910257598.5

(51) Int. Cl. G01M 13/045

(52) U.S. Cl. CPC G01M 13/045

(57) ABSTRACT

A method and apparatus for determining the service life of a bearing. By means of the load spectrum of electric motor output torques under various work conditions comprising different work durations, with respect to a target work condition, utilizing the electric motor output torque corresponding to each work duration, combined with the current vibration load and mesh load of a bearing, the equivalent average load under the target work condition is calculated; thus, the service life of the bearing is determined on the basis of the equivalent average load. As such, the calculated service life of the bearing is of increased accuracy, thereby allowing an improved determination to be made on an operating state of a transmission system, thus increasing the operational reliability of the transmission system.

### CROSS REFERENCE OF RELATED APPLICATION

The present application claims the priority to Chinese Patent Application No. 201910257598.5, titled “METHOD AND APPARATUS FOR DETERMINING SERVICE LIFE OF BEARING”, filed on Apr. 1, 2019 with the China National Intellectual Property Administration, which is incorporated herein by reference in its entirety.

### FIELD

The present disclosure relates to the technical field of bearings, and in particular, to a method and apparatus for determining a service life of a bearing.

### BACKGROUND

Bearings, as an important part of the transmission system in mechanical equipment, are mainly used to support the mechanical rotating body, reduce the friction coefficient of the mechanical rotating body during the movement, and ensure the rotation accuracy of the mechanical rotating body. For the entire transmission system, and even the entire mechanical equipment (e.g. rail transit trains), the service life span of the bearing is related to the use efficiency and operational reliability of the entire transmission system and mechanical equipment. Therefore, if the service life of the bearing can be accurately determined, it will be helpful to effectively evaluate the condition of the transmission system and mechanical equipment. It should be noted that the service life of the bearing can refer to a cumulative working duration of the bearing inner and outer rings or rolling elements when fatigue expansion occurs for the first time.

However, for bearings in the transmission system, calculation for the service life of the bearing is relatively vague at present, and there does be a certain deviation between the calculated service life and the actual service life of the bearing, which leads to inaccurate determination for the working condition of the transmission system with bearings. Take some special transmission systems, such as the bearings of bogie gearboxes, as examples. Due to the special characteristics: the bearings have to bear the variable torque load from the motor and the vibration load caused by the random unevenness of the wheel and rail, it is difficult to accurately calculate the service life of bearings in the bogie gearbox.

### SUMMARY

To solve the above technical problems, a method and apparatus for determining a service life of a bearing are provided according to the embodiments of the present disclosure, so that, even for bearings in some special transmission systems with complex working conditions, the service life of the bearing can be accurately determined. Thus, the working conditions of the transmission system can be better determined, and the reliability of the operation of the transmission system is improved.

Embodiments of the present disclosure may be suitable for accurately calculating the fatigue service life of bogie gearbox bearings of multiple electric-drive traction trains in rail transit and also suitable for calculating the service life of traction motor bearings. It is also applicable to calculate the service life of the axle box bearings of the moving wheel.

In a first aspect, a method for determining a service life of a bearing is provided. The method includes:

obtaining a current vibration load of the bearing, a meshing load of the bearing, and a motor output torque corresponding to each of multiple working durations in a load spectrum under a target work condition, the load spectrum under the target work condition including multiple load spectra under various different working conditions;

calculating an equivalent average load under the target work condition according to the vibration load, the meshing load, and the motor output torque under each of the multiple working durations; and

determining the service life of the bearing according to the equivalent average load.

In an example of the present disclosure, the calculating the equivalent average load under the target work condition according to the vibration load, the meshing load, and the motor output torque under each of the multiple working durations includes:

with respect to each of the multiple working durations in the load spectrum under the target working condition, calculating an equivalent dynamic load under said working duration according to the vibration load, the meshing load, and the motor output torque under said working duration; and

calculating the equivalent average load under the target working condition according to the equivalent dynamic load under each of the multiple working durations under the target working condition, said working duration, and a motor speed under said working duration.

In an example of the present disclosure, the target working condition includes at least one of the following working conditions:

a no-load left-travel working condition, a no-load right-travel working condition, a rated-load left-travel working condition, a rated-load right-travel working condition, an over-load left-travel working condition, and an over-load right-travel working condition.

In an example of the present disclosure, the method further includes:

in a case of no load, obtaining a first left-travel service life and a first left-travel duration corresponding to the no-load left-travel working condition, and a first right-travel service life and a first right-travel duration corresponding to the no-load right-travel working condition;

calculating a first bearing service life with respect to no load according to the first left-travel service life, the first left-travel duration, the first right-travel service life, and the first right-travel duration;

in a case of a rated load, obtaining a second left-travel service life and a second left-travel duration corresponding to the rated-load left-travel working condition, and a second right-travel service life and a second right-travel duration corresponding to the rated-load right-travel working condition;

calculating a second bearing service life with respect to the rated load according to the second left-travel service life, the second left-travel duration, the second right-travel service life, and the second right-travel duration;

in a case of an over load, obtaining a third left-travel service life and a third left-travel duration corresponding to the over-load left-travel working condition, and a third right-travel service life and a third right-travel duration corresponding to the over-load right-travel working condition; and

calculating a third bearing service life with respect to the over load according to the third left-travel service life, the third left-travel duration, the third right-travel service life, and the third right-travel duration.

In an example of the present disclosure, the method further includes:

in a case of travelling on the left, obtaining a first left-travel service life and a first left-travel duration corresponding to the no-load left-travel working condition, a second left-travel service life and a second left-travel duration corresponding to the rated-load left-travel working condition, and a third left-travel service life and a third left-travel duration corresponding to the over-load left-travel working condition;

calculating a fourth bearing service life with respect to travelling on the left according to the first left-travel service life, the first left-travel duration, the second left-travel service life, the second left-travel duration, the third left-travel service life, and the third left-travel duration;

in a case of travelling on the right, obtaining a first right-travel service life and a first right-travel duration corresponding to the no-load right-travel working condition, a second right-travel service life and a second right-travel duration corresponding to the rated-load right-travel working condition, and a third right-travel service life and a third right-travel duration corresponding to the over-load right-travel working condition; and

calculating a fifth bearing service life with respect travelling on the right according to the first right-travel service life, the first right-travel duration, the second right-travel service life, the second right-travel duration, the third right-travel service life, and the third right-travel duration.

In an example of the present disclosure, the method further includes:

calculating a first total duration with respect to no load according to the first left-travel duration and the first right-travel duration with respect to no load;

calculating a second total duration with respect to the rated load according to the second left-travel duration and the second right-travel duration with respect to the rated load;

calculating a third total duration with respect to the over load according to the third left-travel duration and the third right-travel duration with respect to the over load; and

determining a full-working-condition bearing service life of the bearing according to the first total duration, the second total duration, the third total duration, the first bearing service life, the second bearing service life, and the third bearing service life.

In a second aspect, an apparatus for determining a service life of a bearing is provided. The apparatus includes:

a first obtaining unit, configured to obtain a current vibration load of the bearing, a meshing load of the bearing and a motor output torque corresponding to each of multiple working durations in a load spectrum under a target working condition, the load spectrum of the target working condition including multiple load spectra under different working durations;

a first calculating unit, configured to calculate an equivalent average load under the target working condition according to the vibration load, the meshing load, and the motor output torque under each of the multiple working durations; and

a first determining unit, configured to determine the service life of the bearing according to the equivalent average load.

In an example of the present disclosure, the first calculating unit includes:

a first calculating subunit, configured to calculate, with respect to each of the multiple working durations in the load spectrum under the target working condition, an equivalent dynamic load under said working duration according to the vibration load, the meshing load, and the motor output torque under said working duration;

a second calculating subunit, configured to calculate the equivalent average load under the target working condition according to the equivalent dynamic load under each of the multiple working durations under the target working condition, said working duration, and a motor speed under said working duration.

In an example of the present disclosure, the target working condition comprises at least one of the following working conditions:

a no-load left-travel working condition, a no-load right-travel working condition, a rated-load left-travel working condition, a rated-load right-travel working condition, an over-load left-travel working condition, and an over-load right-travel working condition.

In an example of the present disclosure, the apparatus further includes:

a second obtaining unit, configured to obtain, in a case of no load, a first left-travel service life and a first left-travel duration corresponding to the no-load left-travel working condition, and a first right-travel service life and a first right-travel duration corresponding to the no-load right-travel working condition;

a second calculating unit, configured to calculate a first bearing service life with respect to no load according to the first left-travel service life, the first left-travel duration, the first right-travel service life, and the first right-travel duration;

a third obtaining unit, configured to obtain, in a case of a rated load, a second left-travel service life and a second left-travel duration corresponding to the rated-load left-travel working condition, and a second right-travel service life and a second right-travel duration corresponding to the rated-load right-travel working condition;

a third calculating unit, configured to calculate a second bearing service life with respect to the rated load according to the second left-travel service life, the second left-travel duration, the second right-travel service life, and the second right-travel duration;

a fourth obtaining unit, configured to obtain, in a case of an over load, a third left-travel service life and a third left-travel duration corresponding to the over-load left-travel working condition, and a third right-travel service life and a third right-travel duration corresponding to the over-load right-travel working condition; and

a fourth calculating unit, configured to calculate a third bearing service life with respect to the over load according to the third left-travel service life, the third left-travel duration, the third right-travel service life, and the third right-travel duration.

In an example of the present disclosure, the apparatus further includes:

a fifth obtaining unit, configured to obtain, in a case of travelling on the left, a first left-travel service life and a first left-travel duration corresponding to the no-load left-travel working condition, a second left-travel service life and a second left-travel duration corresponding to the rated-load left-travel working condition, and a third left-travel service life and a third left-travel duration corresponding to the over-load left-travel working condition;

a fifth calculating unit, configured to calculate a fourth bearing service life with respect to travelling on the left according to the first left-travel service life, the first left-travel duration, the second left-travel service life, the second left-travel duration, the third left-travel service life, and the third left-travel duration;

a sixth obtaining unit, configured to obtain, in a case of travelling on the right, a first right-travel service life and a first right-travel duration corresponding to the no-load right-travel working condition, a second right-travel service life and a second right-travel duration corresponding to the rated-load right-travel working condition, and a third right-travel service life and a third right-travel duration corresponding to the over-load right-travel working condition; and

a sixth calculating unit, configured to calculate a fifth bearing service life with respect travelling on the right according to the first right-travel service life, the first right-travel duration, the second right-travel service life, the second right-travel duration, the third right-travel service life, and the third right-travel duration.

In an example of the present disclosure, the apparatus further includes:

a seventh calculating unit, configured to calculate a first total duration with respect to no load according to the first left-travel duration and the first right-travel duration with respect to no load, calculate a second total duration with respect to the rated load according to the second left-travel duration and the second right-travel duration with respect to the rated load, and calculate a third total duration with respect to the over load according to the third left-travel duration and the third right-travel duration with respect to the over load; and

a second determining unit, configured to a full-working-condition bearing service life of the bearing according to the first total duration, the second total duration, the third total duration, the first bearing service life, the second bearing service life, and the third bearing service life.

In embodiments of the present disclosure, according to the load spectrum of the motor output torque under various working conditions including multiple different working durations, for the target working condition, the equivalent average load under the target working condition can be calculated according to the motor output torque corresponding to each working duration, the current vibration load of the bearing and the meshing load of the bearing. Moreover, according to the equivalent average load, the service life of the bearing is determined. Thus, since the motor output torque of different working durations under each working condition are introduced, the equivalent average load obtained reflects not only the vibration load caused by the random unevenness of the wheel and rail, but also the characteristic of the variable torque load transmitted by the motor. Therefore, the calculated service life of the bearing is more accurate so that the working condition of the transmission system is better determined, and thereby the reliability of the operation of the transmission system is improved.

### BRIEF DESCRIPTION OF THE DRAWINGS

For clearer illustration of the technical solutions according to embodiments of the present disclosure or conventional techniques, hereinafter briefly described are the drawings to be applied in embodiments of the present disclosure. Apparently, the drawings in the following descriptions are only some embodiments of the present disclosure, and other drawings may be obtained by those skilled in the art based on the provided drawings without creative efforts.

FIG. 1 is a flow chart of a method for determining service life of a bearing according to an embodiment of the present disclosure;

FIG. 2 is a flow chart of an example of step 102 according to an embodiment of the present disclosure; and

FIG. 3 is a schematic structural diagram of an apparatus for determining a service life of a bearing according to an embodiment of the present disclosure.

### DETAILED DESCRIPTION

Nowadays, rail vehicles, which include trains, subways, trams, etc., bring great convenience to people's travel. The bogie is one of the important structures of rail vehicles. The bearing service life in the upper gearbox directly determines the efficiency and reliability of the entire transmission system and even the entire rail vehicle. Generally, a bearing service life refers to a cumulative working duration of the inner and outer rings or rolling elements of the bearing when fatigue expansion occurs for the first time. It is understandable that there is an exponential relationship between the bearing service life and the borne equivalent dynamic load. Therefore, to accurately calculate the bearing service life, it is necessary to calculate the equivalent dynamic load borne by the bearing as accurately as possible.

However, given by lots of researches, it is found that due to its special working conditions, the bogie gearbox has to bear not only the variable torque load transmitted by the motor, but also the vibration load caused by the random unevenness of the wheel and rail. Therefore, it is difficult to accurately calculate the equivalent dynamic load borne by the gearbox bearing. In some implementations, a fixed motor output torque is used for calculating the equivalent dynamic load borne by the gearbox bearing under various working conditions. Since the difference between motor output torques under different working conditions is not considered, the calculated equivalent dynamic load of the bearing is not accurate enough, and the calculated bearing service life is not accurate.

According to this, in the embodiment of the present disclosure, since suppliers of the train traction comprehensively consider factors, such as traction, braking, fluctuations of network voltages, transmission efficiency of mechanical components, and left travel or right travel when trains run according to the actual station spacing, to stimulate the performance of the traction system and calculate a “torque-time-speed” load spectrum of the traction motor (in advance), the bearing service life can be calculated more accurately by applying the “torque-time-speed” load spectrum of the traction motor provided by the suppliers and the cumulative fatigue damage theories when the bearing is subjected to unstable variable forces. An implementation for calculation may include the following. A current vibration load and meshing load of the bearing and a motor output torque corresponding to each working duration in a load spectrum of a target working condition are obtained, where the load spectrum of the target working condition includes multiple load spectra under different working durations. An equivalent average load under the target working condition is calculated according to the vibration load, the meshing load, and the motor output torque under each working duration. The bearing service life is determined according to the equivalent average load.

It can be seen that the bearing service life can be determined in the embodiment of the present disclosure. Since the motor output torque of different working durations under each working condition are introduced, the equivalent average load obtained reflects not only the vibration load caused by the random unevenness of the wheel and rail, but also the characteristic of the variable torque load transmitted by the motor. Therefore, the calculated bearing service life is more accurate so that the working condition of the transmission system is better determined, and thereby the reliability of the operation of the transmission system is improved.

Embodiments of the method for determining a bearing service life in the embodiment of the present disclosure will be described in detail below with reference to the accompanying drawings.

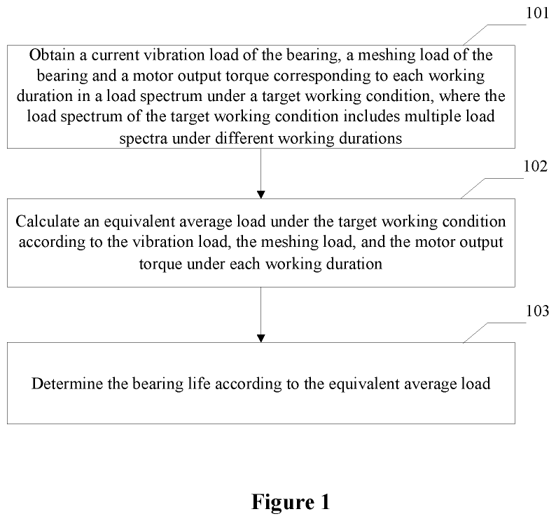

FIG. 1 shows a flow chart of a method for determining service life of a bearing according to an embodiment of the present disclosure. Reference is made to FIG. 1, in which an embodiment of the present disclosure may include steps S101 to S103.

In step S101, a current vibration load of the bearing, a meshing load of the bearing and a motor output torque corresponding to each working duration in a load spectrum under a target working condition are obtained, where the load spectrum of the target working condition includes multiple load spectra under different working durations.

The target working condition includes at least one of the following working conditions: a no-load left-travel working condition, a no-load right-travel working condition, a rated-load left-travel working condition, a rated-load right-travel working condition, an over-load left-travel working condition, and an over-load right-travel working condition.

Suppliers for the train traction provide corresponding “torque-time-speed” load spectrum of the traction motor under various working conditions. For example, a specific load spectrum of the traction motor is shown in Table 1.

Each row in Table 1 is the relevant parameters corresponding to a working duration under the working condition. Specifically, a vehicle speed, loco effort, loco effort per motor, motor speed, and motor output torque under the working duration and the working condition are included.

In a specific implementation, the load spectrum shown in Table 1 can be read to obtain the motor output torque corresponding to each working duration in the load spectrum of the target working condition.

For the current vibration load of the bearing, a current vibration acceleration of the bearing can be measured, and then the vibration load of the bearing can be calculated according to the mass, center of gravity, and current vibration acceleration of the bearing. It should be noted that the current vibration load of the bearing can refer to the Standard IEC61373: “Railway applications—Rolling stock equipment—Shock and vibration tests” stipulated by the International Electrotechnical Commission.

The meshing load is determined according to the design of the gearbox. Specifically, the meshing load of the gear pair in the gearbox can be jointly calculated according to the torque, transmission ratio and other geometric parameters.

According to step 101, obtaining the current vibration load of the bearing, the meshing load of the bearing and the motor output torque corresponding to each working duration in the load spectrum of the target working condition provides a data basis for the subsequent accurate determination of the equivalent average load under the target working condition and the bearing service life.

TABLE 1
″torque-time-speed″ load spectrum of traction motor under certain working

| | | | | | | Motor |
|---|---|---|---|---|---|---|
| | Simulation | Vehicle | Loco | Loco | Motor | output |
| Serial | time step | speed | effort | effort per | speed | torque |
| number | [s] | [km/h] | [kN] | motor [kN] | [RFM] | [N/m] |
| 1 | 0 | 0 | 410 | 17.08333 | 0 | 1364.042 |
| 2 | 1 | 3.9153 | 410 | 17.08333 | 130.1365 | 1364.042 |
| 3 | 2 | 7.8298 | 410 | 17.08333 | 260.2463 | 1364.042 |
| 4 | 3 | 11.7434 | 410 | 17.08333 | 390.3263 | 1364.042 |
| 5 | 4 | 15.6558 | 410 | 17.08333 | 520.3663 | 1364.042 |
| 6 | 5 | 19.5668 | 410 | 17.08333 | 650.3599 | 1364.042 |
| 7 | 6 | 23.4762 | 410 | 17.08333 | 780.3002 | 1364.042 |
| 8 | 7 | 27.3839 | 410 | 17.08333 | 910.1841 | 1364.042 |
| 9 | 8 | 31.2896 | 410 | 17.08333 | 1040.001 | 1364.042 |
| 10 | 9 | 35.1931 | 410 | 17.08333 | 1169.746 | 1364.042 |
| 11 | 10 | 39.0942 | 410 | 17.08333 | 1299.41 | 1364.042 |
| 12 | 11 | 42.9928 | 410 | 17.08333 | 1428.992 | 1364.042 |
| 13 | 12 | 46.8886 | 410 | 17.08333 | 1558.48 | 1364.042 |
| 14 | 13 | 50.7815 | 410 | 17.08333 | 1687.872 | 1364.042 |
| 15 | 14 | 54.6712 | 410 | 17.08333 | 1817.157 | 1364.042 |
| 16 | 15 | 58.5575 | 401 | 16.70833 | 1946.33 | 1334.1 |
| 17 | 16 | 62.3533 | 379.7 | 15.82083 | 2072.494 | 1263.236 |
| 18 | 17 | 65.94 | 359.5 | 14.97917 | 2191.709 | 1196.032 |
| 19 | 18 | 69.3291 | 340.5 | 14.1875 | 2304.356 | 1132.82 |
| 20 | 19 | 72.5313 | 323.5 | 13.47917 | 2410.79 | 1076.263 |
| 21 | 20 | 75.5662 | 312 | 13 | 2511.661 | 1038.003 |
| 22 | 21 | 78.4867 | 300.9 | 12.5375 | 2608.735 | 1001.074 |

In step S102, an equivalent average load under the target working condition is calculated according to the vibration load, the meshing load, and the motor output torque under each working duration.

The equivalent dynamic load means that when the bearing is subjected to combined radial and axial loads at the same time, the actual load is converted into an equivalent dynamic load with conditions consistent with the determined dynamic load rating. In other words, the bearing service life calculated by the equivalent dynamic load has the same measurement standard and can be compared under the same conditions.

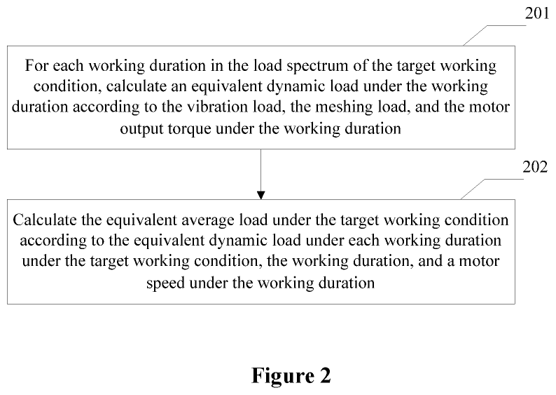

In a specific implementation, step S102 can be referred to FIG. 2, which includes steps S201 to S202.

In step S201, for each working duration in the load spectrum of the target working condition, an equivalent dynamic load under the working duration is calculated according to the vibration load, the meshing load, and the motor output torque under the working duration.

For each working duration in the target load spectrum, the vibration load, the meshing load, and the motor output torque under the working duration, the equivalent dynamic load under the working duration can be calculated according to a preset calculation equation. For example, for each row corresponding to Table 1, the equivalent dynamic load corresponding to the row is calculated according to the vibration load, the meshing load and the motor output torque in the row.

Specifically, if the load spectrum of N (N is a positive integer) working durations is provided under the working condition, for these N working durations, the corresponding N equivalent dynamic loads Fᵢ (i=1,2, . . . ,N) can be calculated according to the motor output torque corresponding to each working duration.

The calculation equation for the “calculating the equivalent dynamic load according to the vibration load, the meshing load and the motor output torque” can be preconfigured by technicians based on theories and experiences. As long as calculating a reasonable equivalent dynamic load, it can be configured as the calculation equation, which is not specifically limited in this embodiment.

In step S202, the equivalent average load under the target working condition is calculated according to the equivalent dynamic load under each working duration under the target working condition, the working duration, and a motor speed under the working duration.

For a target working condition, the equivalent average load Fₘ under the target working condition can be calculated according to the current dynamic load Fᵢ corresponding to each working duration under the target working condition.

As an example, in step 202, the equivalent average load under the target working condition may be specifically calculated according to the following Equation (1).

$${F}_{m} = {[ \frac{\sum ( {F}_{i}^{ɛ} \times {n}_{i} \times {u}_{i} )}{\sum ( {n}_{i} \times {u}_{i} )} ]}^{1 / ɛ} \qquad Equation ( 1 )$$

Where, uᵢ is the working duration corresponding to i^{th} working duration, and its unit can be second; Fᵢ is the equivalent dynamic load calculated according to step 201 under i^{th} working duration, and its unit can be cattle; nᵢ is the motor speed under i^{th} working duration, and its unit can be revolutions per minute; ε is the index of the bearing service life, which is a constant; Fₘ is the equivalent average load under the target working condition.

Since during the equivalent average load calculated, specific data, such as motor output torque, working duration, and motor speed, of each working duration in the “torque-time-speed” load spectrum of the traction motor are introduced, and the fatigue accumulation theory is applied, the calculated equivalent average load can more accurately reflect the bearing conditions, so as to provide a data basis for the subsequent accurate determination of the bearing service life.

In step S103, the bearing service life is determined according to the equivalent average load.

In an implementation, the following Equation (2) can be configured to calculate the bearing service life.

$${L}_{10 m} = {( \frac{c}{{F}_{m}} )}^{ɛ} \qquad Equation ( 2 )$$

Where, C is the rated load of the bearing, which is a constant; ε is the index of the bearing service life, which is a constant; Fₘ is the equivalent average load under the target working condition; L₁₀ₘ, is the bearing service life under the target working condition.

In the embodiment of the present disclosure, according to the load spectrum of the motor output torque under various working conditions including multiple different working durations, for the target working condition, the equivalent average load under the target working condition can be calculated according to the motor output torque corresponding to each working duration, and the current vibration load and meshing load of the bearing. Moreover, according to the equivalent average load, the bearing service life is determined. Thus, since the motor output torque of different working durations under each working condition are introduced, the equivalent average load obtained reflects not only the vibration load caused by the random unevenness of the wheel and rail, but also the characteristic of the variable torque load transmitted by the motor. Therefore, the calculated bearing service life is more accurate so that the working condition of the transmission system is better determined, and thereby the reliability of the operation of the transmission system is improved.

In addition, for different target working conditions, the above manner can be applied to calculate accurately the corresponding bearing service life. For different target working conditions, combinations of target working conditions, and full working condition, embodiments of determining the bearing service life are introduced separately as the following.

Situation 1

In a case of no load, an implementation for calculating a first bearing service life corresponding to no load may include steps S11 to S12.

In step S11, a first left-travel service life and a first left-travel duration corresponding to the no-load left-travel working condition, and a first right-travel service life and a first right-travel duration corresponding to the no-load right-travel working condition are obtained.

In step S12, a first bearing service life of no load is calculated according to the first left-travel service life, the first left-travel duration, the first right-travel service life, and the first right-travel duration.

As an example, the no-load left-travel working condition is set as the target working condition. According to the embodiment corresponding to FIG. 1, the bearing service life can be calculated, which is recorded as the first left-travel service life. Similarly, the no-load right-travel working condition is set as the target working condition. According to the embodiment corresponding to FIG. 1, the bearing service life can be calculated, which is recorded as the first right-travel service life. Moreover, according to the “torque-time-speed” load spectrum of the traction motor corresponding to each target working condition, the maximum working duration in the load spectrum corresponding to the no-load left-travel working condition can be looked up and be determined as the first left-travel duration. Similarly, the maximum working duration of the load spectrum corresponding to the no-load right-travel working condition can be looked up and be determined as the first right-travel duration. A preset calculation equation can be applied to calculate the first bearing service life under the no-load working condition (including the no-load left-travel working condition and the no-load right-travel working condition). For example, the first bearing service life can be calculated according to the following equation (3).

$${L}_{{10}_{1}} = \frac{1}{( \frac{a}{{L}_{10 m a}} + \frac{b}{{L}_{10 m b}} )} \qquad Equation ( 3 )$$

where, α is the first left-travel duration, b is the first right-travel duration, L₁₀ₘₐ is the first left-travel service life, L_{10mb} is the first right-travel service life, and L₁₀_{₁} is the first bearing service life of rated load.

Situation 2

In a case of rated load, an implementation for calculating a second bearing service life corresponding to rated load may include steps S21 to S22.

In step S21, a second left-travel service life and a second left-travel duration corresponding to the rated-load left-travel working condition, and a second right-travel service life and a second right-travel duration corresponding to the rated-load right-travel working condition are obtained.

In step S22, a second bearing service life of rated load is calculated according to the second left-travel service life, the second left-travel duration, the second right-travel service life, and the second right-travel duration.

For the specific description, the related introduction for no load can be referred to.

For example, the second bearing service life can be calculated according to the following equation (4).

$${L}_{{10}_{2}} = \frac{1}{( \frac{c}{{L}_{10 m c}} + \frac{d}{{L}_{10 m d}} )} \qquad Equation ( 4 )$$

where, c is the second left-travel duration, d is the second right-travel duration, L_{10mc} is the second left-travel service life, L_{10md} is the second right-travel service life, and L₁₀_{₂} is the second bearing service life of rated load.

Situation 3

In a case of over load, an implementation for calculating a third bearing service life corresponding to rated load may include steps S31 to S32.

In step S31, a third left-travel service life and a third left-travel duration corresponding to the over-load left-travel working condition, and a third right-travel service life and a third right-travel duration corresponding to the over-load right-travel working condition are obtained.

In step S32, a third bearing service life of over load is calculated according to the third left-travel service life, the third left-travel duration, the third right-travel service life, and the third right-travel duration.

For the specific description, the related introduction for no load can be referred to.

For example, the third bearing service life can be calculated according to the following equation (5).

$${L}_{1 {0}_{3}} = \frac{1}{( \frac{e}{{L}_{10 m e}} + \frac{f}{{L}_{10 mf}} )} \qquad Equation ( 5 )$$

where, e is the third left-travel duration, f is the third right-travel duration, L₁₀ₘₑ is the third left-travel service life, L_{10mf} is the third right-travel service life, and L₁₀_{₃} is the third bearing service life of over load.

It should be noted that the above L₁₀ₘₐ, L_{10mb}, L_{10mc}, L_{10md}, L₁₀ₘₑ, and L_{10mf} may all be calculated according to the embodiment corresponding to FIG. 1 with the corresponding working condition as the target working condition.

Situation 4

In a case of left travel, an implementation for calculating a fourth bearing service life corresponding to left travel may include steps S41 to S42.

In step S41, a first left-travel service life and a first left-travel duration corresponding to the no-load left-travel working condition are obtained, a second left-travel service life and a second left-travel duration corresponding to the rated-load left-travel working condition are obtained, and a third left-travel service life and a third left-travel duration corresponding to the over-load left-travel working condition are obtained.

In step S42, a fourth bearing service life of left travel is calculated according to the first left-travel service life, the first left-travel duration, the second left-travel service life, the second left-travel duration, the third left-travel service life, and the third left-travel duration.

As an example, the no-load left-travel working condition is set as the target working condition. According to the embodiment corresponding to FIG. 1, the bearing service life can be calculated, which is recorded as the first left-travel service life. Similarly, the rated-load left-travel working condition is set as the target working condition. According to the embodiment corresponding to FIG. 1, the bearing service life can be calculated, which is recorded as the second left-travel service life. The over-load left-travel working condition is set as the target working condition. According to the embodiment corresponding to FIG. 1, the bearing service life can be calculated, which is recorded as the third left-travel service life. Moreover, according to the “torque-time-speed” load spectrum of the traction motor corresponding to each target working condition, the maximum working duration in the load spectrum corresponding to the no-load left-travel working condition can be looked up and be determined as the first left-travel duration. Similarly, the maximum working duration of the load spectrum corresponding to the rated-load left-travel working condition can be looked up and be determined as the second left-travel duration. The maximum working duration of the load spectrum corresponding to the over-load left-travel working condition can be looked up and be determined as the third left-travel duration. A preset calculation equation can be applied to calculate the fourth bearing service life under the left-travel working condition (including the no-load left-travel working condition, rated-load left-travel working condition, and over-load left-travel working condition). For example, the fourth bearing service life can be calculated according to the following equation (6).

$${L}_{1 {0}_{4}} = \frac{1}{( \frac{a}{{L}_{10 m a}} + \frac{c}{{L}_{10 m c}} + \frac{e}{{L}_{10 m e}} )} \qquad Equation ( 6 )$$

where, a is the first left-travel duration, c is the second left-travel duration, e is the third left-travel duration, L₁₀ₘₐ is the first left-travel service life, L_{10mc} is the second left-travel service life, L₁₀ₘₑ is the third left-travel service life, and L₁₀_{₄} is the fourth bearing service life of left travel.

Situation 5

In a case of right travel, an implementation for calculating a fifth bearing service life corresponding to right travel may include steps S51 to S52.

In step S51, a first right-travel service life and a first right-travel duration corresponding to the no-load right-travel working condition are obtained, a second right-travel service life and a second right-travel duration corresponding to the rated-load right-travel working condition are obtained, and a third right-travel service life and a third right-travel duration corresponding to the over-load right-travel working condition are obtained.

In step S52, a fifth bearing service life of right travel is calculated according to the first right-travel service life, the first right-travel duration, the second right-travel service life, the second right-travel duration, the third right-travel service life, and the third right-travel duration.

For the specific description, the related introduction for left travel can be referred to.

For example, the fifth bearing service life can be calculated according to the following equation (7).

$${L}_{{10}_{5}} = \frac{1}{( \frac{b}{{L}_{10 m b}} + \frac{d}{{L}_{10 m d}} + \frac{f}{{L}_{10 mf}} )} \qquad Equation ( 7 )$$

where, b is the first right-travel duration, d is the second right-travel duration, f is the third right-travel duration, L_{10mb} is the first right-travel service life, L_{10md} is the second right-travel service life, L_{10mf} is the third right-travel service life, and L₁₀_{₅} is the fifth bearing service life of right travel.

Situation 6

In a case of full working conditions, for calculating a full-working-condition bearing service life corresponding to full working conditions, there may be specifically the following two implementations. An implementation may specifically include steps S611 to S612.

In step S611, a first total duration of no load is calculated according to the first left-travel duration and the first right-travel duration corresponding to no load; a second total duration of rated load is calculated according to the second left-travel duration and the second right-travel duration corresponding to rated load; a third total duration of over load is calculated according to the third left-travel duration and the third right-travel duration corresponding to over load.

In step S612, a full-working-condition bearing service life is determined according to the first total duration, the second total duration, the third total duration, the first bearing service life, the second bearing service life, and the third bearing service life.

For example, the full-working-condition bearing service life can be calculated according to the following equation (8).

$${L}_{10} = \frac{1}{( \frac{o}{{L}_{1 {0}_{1}}} + \frac{p}{{L}_{1 {0}_{2}}} + \frac{q}{{L}_{1 {0}_{3}}} )} \qquad Equation ( 8 )$$

where, o is a sum of the first left-travel duration a and the first right-travel duration b; p is a sum of the second left-travel duration c and the second right-travel duration d; q is a sum of the third left-travel duration e and the third right-travel duration L₁₀ is the full-working-condition service life.

Another implementation may specifically include steps S621 to S622.

In step S621, a fourth bearing service life of left travel is calculated according to the first left-travel service life, the first left-travel duration, the second left-travel service life, the second left-travel duration, the third left-travel service life, and the third left-travel duration; a fifth bearing service life of right travel is calculated according to the first right-travel service life, the first right-travel duration, the second right-travel service life, the second right-travel duration, the third right-travel service life, and the third right-travel duration.

In step S622, a full-working-condition bearing service life is determined according to the fourth total duration, the fifth total duration, the first bearing service life, the fourth bearing service life, and the fifth bearing service life.

For example, the full-working-condition bearing service life can be calculated according to the following equation (9).

$${L}_{10} = \frac{1}{( \frac{h}{{L}_{1 {0}_{4}}} + \frac{k}{{L}_{{10}_{5}}} )} \qquad Equation ( 9 )$$

where, h is a sum of the first left-travel duration a, the second left-travel duration c, and the third left-travel duration e (i.e., the fourth total duration); k is a sum of the first right-travel duration b, the second right-travel duration d, and the third right-travel duration f (i.e., the fifth total duration); L_{10mb} is the first right-travel service life; L₁₀ is the full-working-condition service life.

It should be noted that, for a bearing in the same bogie gearbox on the same train, the full-working-condition bearing service life calculated according to steps S611 to S612 is the same as that calculated according to steps S621 to S622.

Thus, since the motor output torque of different working durations under each working condition are introduced, the equivalent average load obtained reflects not only the vibration load caused by the random unevenness of the wheel and rail, but also the characteristic of the variable torque load transmitted by the motor. Therefore, the calculated bearing service life is more accurate so that the working condition of the transmission system is better determined, and thereby the reliability of the operation of the transmission system is improved.

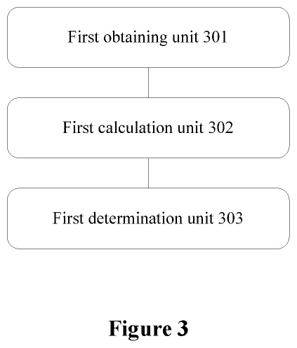

In addition, an apparatus for determining a bearing service life is provided according to an embodiment of the present disclosure. Reference is made to FIG. 3, which shows a schematic structural diagram of an apparatus for determining service life of a bearing according to an embodiment of the present disclosure. The apparatus includes units 301 to 303:

a first obtaining unit 301, configured to obtain a current vibration load of the bearing, a meshing load of the bearing, and a motor output torque corresponding to each working duration in a load spectrum of a target working condition; the load spectrum of the target working condition includes multiple load spectra under different working durations;

a first calculating unit 302, configured to calculate an equivalent average load under the target working condition according to the vibration load, the meshing load, and the motor output torque under each working duration, and

a first determining unit 303, configured to determine the bearing service life according to the equivalent average load.

In an embodiment, the first calculating unit 302 further includes the following:

a first calculating subunit, configured to, for each working duration in the load spectrum of the target working condition, calculate an equivalent dynamic load under the working duration according to the vibration load, the meshing load, and the motor output torque under the working duration, and

a second calculating subunit, configured to calculate the equivalent average load under the target working condition according to the equivalent dynamic load under each working duration under the target working condition, the working duration, and a motor speed under the working duration.

In an embodiment, the target working condition includes at least one of the following working conditions: a no-load left-travel working condition, a no-load right-travel working condition, a rated-load left-travel working condition, a rated-load right-travel working condition, an over-load left-travel working condition, and an over-load right-travel working condition.

In an embodiment, the apparatus further includes the following:

a second obtaining unit, configured to obtain, in a case of no load, a first left-travel service life and a first left-travel duration corresponding to the no-load left-travel working condition, and a first right-travel service life and a first right-travel duration corresponding to the no-load right-travel working condition;

a second calculating unit, configured to calculate a first bearing service life of no load according to the first left-travel service life, the first left-travel duration, the first right-travel service life, and the first right-travel duration;

a third obtaining unit, configured to obtain, in a case of rated load, a second left-travel service life and a second left-travel duration corresponding to the rated-load left-travel working condition, and a second right-travel service life and a second right-travel duration corresponding to the rated-load right-travel working condition;

a third calculating unit, configured to calculate a second bearing service life of rated load according to the second left-travel service life, the second left-travel duration, the second right-travel service life, and the second right-travel duration;

a fourth obtaining unit, configured to obtain, in a case of over load, a third left-travel service life and a third left-travel duration corresponding to the over-load left-travel working condition, and a third right-travel service life and a third right-travel duration corresponding to the over-load right-travel working condition, and

a fourth calculating unit, configured to calculate a third bearing service life of over load according to the third left-travel service life, the third left-travel duration, the third right-travel service life, and the third right-travel duration.

In an embodiment, the apparatus further includes the following:

a fifth obtaining unit, configured to, in a case of left travel, obtain a first left-travel service life and a first left-travel duration corresponding to the no-load left-travel working condition, obtain a second left-travel service life and a second left-travel duration corresponding to the rated-load left-travel working condition, and obtain a third left-travel service life and a third left-travel duration corresponding to the over-load left-travel working condition;

a fifth calculating unit, configured to calculate a fourth bearing service life of left travel according to the first left-travel service life, the first left-travel duration, the second left-travel service life, the second left-travel duration, the third left-travel service life, and the third left-travel duration;

a sixth obtaining unit, configured to, in a case of right travel, obtain a first right-travel service life and a first right-travel duration corresponding to the no-load right-travel working condition, obtain a second right-travel service life and a second right-travel duration corresponding to the rated-load right-travel working condition, and obtain a third right-travel service life and a third right-travel duration corresponding to the over-load right-travel working condition, and

a sixth calculating unit, configured to calculate a fifth bearing service life of right travel according to the first right-travel service life, the first right-travel duration, the second right-travel service life, the second right-travel duration, the third right-travel service life, and the third right-travel duration.

In an embodiment, the apparatus further includes the following:

a seventh calculating unit, configured to calculate a first total duration of no load according to the first left-travel duration and the first right-travel duration corresponding to no load; calculate a second total duration of rated load according to the second left-travel duration and the second right-travel duration corresponding to rated load; calculate a third total duration of over load according to the third left-travel duration and the third right-travel duration corresponding to over load, and

a second determining unit, configured to determine a full-working-condition bearing service life according to the first total duration, the second total duration, the third total duration, the first bearing service life, the second bearing service life, and the third bearing service life.

It should be noted that the above is a description of an apparatus for determining the bearing service life. For specific implementation and the effects it may achieved, the description of the above method for determining the bearing service life can be referred to, which will not be repeated herein.

The “first” in the names of “first left-travel duration”, “first left-travel service life” and the like mentioned in the embodiments of the present disclosure is only used for name identification, and does not mean the first in order. This rule also applies to “second” and so on.

From the description of the foregoing embodiments, those skilled in the art can clearly understand that all or part of the steps of methods in the foregoing embodiments can be implemented by means of software plus a general hardware platform. According to this understanding, the technical solution of the present disclosure can be embodied in the form of a software product. The computer software product can be stored in storage media, such as read-only memory (ROM)/RAM, magnetic disks, optical disks, etc., which include instructions to enable a computer device (which may be a personal computer, a server, or a network communication device such as a router) to execute the method described in each embodiment or some parts of the embodiments of the present disclosure.

The embodiments of the present disclosure are described in a progressive manner, and each embodiment places emphasis on the difference from other embodiments. Therefore, one embodiment can refer to other embodiments for the same or similar parts. For the apparatuses disclosed in the embodiments, since they correspond to the methods disclosed in the embodiments, the description is relatively simple, and the relevant parts can be referred to the description of the methods. The apparatus embodiments described above are merely illustrative. The modules described as separate components may or may not be physically separated, and the components displayed as modules may or may not be physical modules, that is, it can be located in one place, or it can be distributed to multiple network units. Some or all of the modules may be selected according to actual needs to achieve the objectives of the solutions of the embodiments. Those of ordinary skill in the art can understand and implement without creative work.

1. A method for determining service life of a bearing, comprising:
obtaining a current vibration load of the bearing, a meshing load of the bearing, and a motor output torque corresponding to each of a plurality of working durations in a load spectrum under a target work condition, the load spectrum under the target work condition comprising a plurality of load spectra under various different working conditions;
calculating an equivalent average load under the target work condition according to the vibration load, the meshing load, and the motor output torque under each of the plurality of working durations; and
determining the service life of the bearing according to the equivalent average load.

2. The method according to claim 1, wherein the calculating the equivalent average load under the target work condition according to the vibration load, the meshing load, and the motor output torque under each of the plurality of working durations comprises:
with respect to each of the plurality of working durations in the load spectrum under the target working condition, calculating an equivalent dynamic load under said working duration according to the vibration load, the meshing load, and the motor output torque under said working duration; and
calculating the equivalent average load under the target working condition according to the equivalent dynamic load under each of the plurality of working durations under the target working condition, said working duration, and a motor speed under said working duration.

3. The method according to claim 1, wherein the target working condition comprises at least one of the following working conditions:
a no-load left-travel working condition, a no-load right-travel working condition, a rated-load left-travel working condition, a rated-load right-travel working condition, an over-load left-travel working condition, and an over-load right-travel working condition.

4. The method according to claim 3, wherein,
in a case of no load, the method further comprises:
obtaining a first left-travel service life and a first left-travel duration corresponding to the no-load left-travel working condition, and a first right-travel service life and a first right-travel duration corresponding to the no-load right-travel working condition; and
calculating a first bearing service life with respect to no load according to the first left-travel service life, the first left-travel duration, the first right-travel service life, and the first right-travel duration;
in a case of a rated load, the method further comprises:
obtaining a second left-travel service life and a second left-travel duration corresponding to the rated-load left-travel working condition, and a second right-travel service life and a second right-travel duration corresponding to the rated-load right-travel working condition; and
calculating a second bearing service life with respect to the rated load according to the second left-travel service life, the second left-travel duration, the second right-travel service life, and the second right-travel duration; and
in a case of an over load, the method further comprises:
obtaining a third left-travel service life and a third left-travel duration corresponding to the over-load left-travel working condition, and a third right-travel service life and a third right-travel duration corresponding to the over-load right-travel working condition; and
calculating a third bearing service life with respect to the over load according to the third left-travel service life, the third left-travel duration, the third right-travel service life, and the third right-travel duration.

5. The method according to claim 3, wherein,
in a case of travelling on the left, the method further comprises:
obtaining a first left-travel service life and a first left-travel duration corresponding to the no-load left-travel working condition, a second left-travel service life and a second left-travel duration corresponding to the rated-load left-travel working condition, and a third left-travel service life and a third left-travel duration corresponding to the over-load left-travel working condition;
calculating a fourth bearing service life with respect to travelling on the left according to the first left-travel service life, the first left-travel duration, the second left-travel service life, the second left-travel duration, the third left-travel service life, and the third left-travel duration; and
in a case of travelling on the right, the method further comprises:
obtaining a first right-travel service life and a first right-travel duration corresponding to the no-load right-travel working condition, a second right-travel service life and a second right-travel duration corresponding to the rated-load right-travel working condition, and a third right-travel service life and a third right-travel duration corresponding to the over-load right-travel working condition; and
calculating a fifth bearing service life with respect travelling on the right according to the first right-travel service life, the first right-travel duration, the second right-travel service life, the second right-travel duration, the third right-travel service life, and the third right-travel duration.

6. The method according to claim 4, further comprising:
calculating a first total duration with respect to no load according to the first left-travel duration and the first right-travel duration with respect to no load;
calculating a second total duration with respect to the rated load according to the second left-travel duration and the second right-travel duration with respect to the rated load;
calculating a third total duration with respect to the over load according to the third left-travel duration and the third right-travel duration with respect to the over load; and
determining a full-working-condition bearing service life of the bearing according to the first total duration, the second total duration, the third total duration, the first bearing service life, the second bearing service life, and the third bearing service life.

7. An apparatus for determining a bearing service life, comprising:
a first obtaining unit, configured to obtain a current vibration load of the bearing, a meshing load of the bearing and a motor output torque corresponding to each of a plurality of working durations in a load spectrum under a target working condition, the load spectrum of the target working condition comprising a plurality of load spectra under different working durations;
a first calculating unit, configured to calculate an equivalent average load under the target working condition according to the vibration load, the meshing load, and the motor output torque under each of the plurality of working durations; and
a first determining unit, configured to determine the service life of the bearing according to the equivalent average load.

8. The apparatus according to claim 7, the first calculating unit comprising:
a first calculating subunit, configured to calculate, with respect to each of the plurality of working durations in the load spectrum under the target working condition, an equivalent dynamic load under said working duration according to the vibration load, the meshing load, and the motor output torque under said working duration;
a second calculating subunit, configured to calculate the equivalent average load under the target working condition according to the equivalent dynamic load under each of the plurality of working durations under the target working condition, said working duration, and a motor speed under said working duration.

9. The apparatus according to claim 7, wherein the target working condition comprises at least one of the following working conditions:
a no-load left-travel working condition, a no-load right-travel working condition, a rated-load left-travel working condition, a rated-load right-travel working condition, an over-load left-travel working condition, and an over-load right-travel working condition.

10. The apparatus according to claim 9, further comprising:
a second obtaining unit, configured to obtain, in a case of no load, a first left-travel service life and a first left-travel duration corresponding to the no-load left-travel working condition, and a first right-travel service life and a first right-travel duration corresponding to the no-load right-travel working condition;
a second calculating unit, configured to calculate a first bearing service life with respect to no load according to the first left-travel service life, the first left-travel duration, the first right-travel service life, and the first right-travel duration;
a third obtaining unit, configured to obtain, in a case of a rated load, a second left-travel service life and a second left-travel duration corresponding to the rated-load left-travel working condition, and a second right-travel service life and a second right-travel duration corresponding to the rated-load right-travel working condition;
a third calculating unit, configured to calculate a second bearing service life with respect to the rated load according to the second left-travel service life, the second left-travel duration, the second right-travel service life, and the second right-travel duration;
a fourth obtaining unit, configured to obtain, in a case of an over load, a third left-travel service life and a third left-travel duration corresponding to the over-load left-travel working condition, and a third right-travel service life and a third right-travel duration corresponding to the over-load right-travel working condition; and
a fourth calculating unit, configured to calculate a third bearing service life with respect to the over load according to the third left-travel service life, the third left-travel duration, the third right-travel service life, and the third right-travel duration.

11. The apparatus according to claim 9, further comprising:
a fifth obtaining unit, configured to obtain, in a case of travelling on the left, a first left-travel service life and a first left-travel duration corresponding to the no-load left-travel working condition, a second left-travel service life and a second left-travel duration corresponding to the rated-load left-travel working condition, and a third left-travel service life and a third left-travel duration corresponding to the over-load left-travel working condition;
a fifth calculating unit, configured to calculate a fourth bearing service life with respect to travelling on the left according to the first left-travel service life, the first left-travel duration, the second left-travel service life, the second left-travel duration, the third left-travel service life, and the third left-travel duration;
a sixth obtaining unit, configured to obtain, in a case of travelling on the right, a first right-travel service life and a first right-travel duration corresponding to the no-load right-travel working condition, a second right-travel service life and a second right-travel duration corresponding to the rated-load right-travel working condition, and a third right-travel service life and a third right-travel duration corresponding to the over-load right-travel working condition; and
a sixth calculating unit, configured to calculate a fifth bearing service life with respect travelling on the right according to the first right-travel service life, the first right-travel duration, the second right-travel service life, the second right-travel duration, the third right-travel service life, and the third right-travel duration.

12. The apparatus according to claim 10, further comprising:
a seventh calculating unit, configured to calculate a first total duration with respect to no load according to the first left-travel duration and the first right-travel duration with respect to no load, calculate a second total duration with respect to the rated load according to the second left-travel duration and the second right-travel duration with respect to the rated load, and calculate a third total duration with respect to the over load according to the third left-travel duration and the third right-travel duration with respect to the over load; and
a second determining unit, configured to a full-working-condition bearing service life of the bearing according to the first total duration, the second total duration, the third total duration, the first bearing service life, the second bearing service life, and the third bearing service life.
